(19) United States
(12) Patent Application Publication
(10) Pub. No.: US 2021/0186211 A1
(43) Pub. Date: Jun. 24, 2021

(54) Shelving System for Resisting Applied Shear Forces and Method for Forming the Same

(71) Applicant: Cambro Manufacturing Company, Huntington Beach, CA (US)

(72) Inventor: Jorge Baez, Lake Forest, CA (US)

(21) Appl. No.: 16/722,695

(22) Filed: Dec. 20, 2019

(51) Int. Cl. A47B 57/54; A47B 47/04

(52) U.S. Cl. CPC A47B 57/545; A47B 2230/0077; A47B 47/045

(57) ABSTRACT

A shelving system formed by a plurality of vertical posts and horizontal traverses held together through frictional engagement. Disposed between each lateral pair of posts are a pair of post connectors which include a female frictional engagement member configured to engage with a male frictional engagement member disposed on each post. The post and post connector engage with each other so as to create a proportional reaction force in response to any shear force applied to the shelving system. Disposed between each longitudinal pair of posts is at least one traverse which includes a collar configured to engage with one of a plurality of male components disposed along the height of the post. Each of the male components have a tapered shape which matches a tapered shape of a female aperture defined within the collar so as to form a closely fitted coupling between the post and each traverse.

### BACKGROUND

### Field of the Technology

The invention relates to the field of shelving and shelving systems, particularly to shelving units which are easily assembled from a plurality of components without comprising the structural integrity of the shelving unit.

### Description of the Prior Art

Utility or commercial shelving units or shelving systems comprised of different types of materials have long been used in art. Some of the materials commonly used include wood, metal, plastic or plastic composites. Many of these prior art shelving systems have a plurality of shelves which can either be fixed at certain predetermined heights or may be adjustable to one of a series of available heights using an adjustable coupling means such as clamps, buckles, or sliding and locking mounts. Some shelving systems also include drawers or cabinets as well.

While many of the prior art designs are not without their respective merits, several limitations found in the prior art have become apparent. The first and most crucial of these limitations is the ratio of the load that may be supported by the shelving system to the weight of the shelving system itself. For example, a shelving system that is infused with concrete or reinforced steel may be able to support a relatively large load, however the weight that is added to the shelving system makes the entire system cumbersome and difficult to reconfigure or adjust to the specific needs of any specific user. On the other hand, if a shelving system is too light, the load it can support may be severely restricted thus limiting the scope of use of the shelving system.

Additionally, for shelving systems with shelves that may be adjusted to a user determined height, the means for coupling the shelves to their support posts can be overly complicated or inconvenient. Adjustable coupling means that are too complicated are more prone to malfunction and can add additional unnecessary weight to the shelving system. Inconvenient coupling means may similarly be difficult to use or require at least two people to operate.

Relatedly, many shelving units or shelving systems are manufactured in multiple parts which are delivered to the consumer who must then assemble the shelving unit before using it. Cumbersome or overly complicated coupling means not only make the shelving system more difficult or inconvenient to use, but the more complicated the means for assembling the shelf unit, the more likely that the user will improperly construct the shelf unit which could therefore lead to a structural failure. For example, if the user improperly or incompletely joins a traverse of a shelf to a vertical post and then places a weight on the shelf, the odds of the traverse decoupling from the post or otherwise failing is dramatically increased. As a result therefore, the maximum weight capacity of the shelving system is dramatically reduced, if not completely nullified. Additionally, when a shear force or stress is applied to the shelving system, such as when a user or other object bumps into or collides with the system, the applied force can cause the connection points of the shelving system to weaken or even fail completely.

What is needed is a shelving system that is strong enough to support large load distributions and yet still capable of resisting any shear forces which are applied to the shelving system without comprising the overall structural integrity of the shelving system itself. Additionally, the shelving system should be easily assembled from a plurality of parts in such a manner so as to prevent a user from incorrectly constructing the shelving system and perhaps compromising its structural integrity in the process.

### BRIEF SUMMARY

The current invention provides a shelving system for resisting and responding to a shear force which is applied to the shelving system. The shelving system includes a plurality of posts and a plurality of post connectors, each one of the plurality of post connectors being connected to at least two of the plurality of posts. Specifically, each of the plurality of posts includes a male engagement member and each of the plurality of post connectors comprises at least one female engagement member, the male engagement member being configured to apply a reaction force in any direction to the at least one female engagement member in response to a shear force applied to the shelving system.

In one embodiment, the male engagement member disposed on each of the plurality of posts is specifically configured to apply a reaction force to the female engagement member disposed on each of the plurality of post connectors when the male engagement member is inserted into the female engagement member. Here, the male engagement member and the female engagement member are in surface contact over a majority of their respective surfaces when the male engagement member is inserted into the female engagement member.

In another embodiment, the female engagement member disposed on each of the plurality of post connectors is defined within a surface of a post cap that is disposed on a lateral end of each of the plurality of post connectors. The post cap further includes an internal volume capable of accommodating a top portion of the plurality of posts.

In yet another embodiment, the female engagement member disposed on each of the plurality of post connectors is specifically defined in a surface of a post sleeve that is disposed on a lateral end of each of the plurality of post connectors. Each post sleeve further includes a hollow interior capable of threading a bottom portion of the plurality of posts there through.

In one particular embodiment, the shelving system also includes a plurality of traverses and a plurality of traverse coupling positions that are disposed along the height of each of the plurality of posts. Each of the plurality of traverses are removably coupled to the plurality of traverse coupling positions of two of the plurality of posts. In this embodiment, each of the plurality of traverses has a traverse end piece located at each of its lateral ends. Each traverse end piece is capable of being connected to either a first male component or a second male component which make up or constitute each of the plurality of traverse coupling positions.

In another embodiment, the male engagement member and the female engagement member form a plane when the male engagement member is inserted into the female engagement member so that the reaction force applied in any direction to the female engagement member is parallel to the plane formed by the combined male engagement member and female engagement member.

In yet another embodiment, two of the male engagement members located on two of the plurality of posts are inserted into two female engagement members that are located on opposing lateral ends of each of the plurality of post connectors.

In a further embodiment, each of the plurality of post connectors include means for frictionally engaging the surface of the plurality of posts.

The invention also provides a system for forming a shelf unit. The system includes a plurality of posts, each of the posts having of at least one male engagement member. The system also includes a plurality of top post connectors and separate plurality of bottom post connectors, each of which has at least two female engagement members disposed thereon. The male engagement member of each of the plurality of posts includes a rounded surface, while the female engagement members of each of the top and bottom post connectors each include a concave surface which is capable of accommodating the rounded surface of the male engagement member.

In one embodiment, the system also includes a post cap or a post sleeve located at either lateral end of each of the plurality of top post connectors and bottom post connectors, respectively. Here, the female engagement members of both the plurality of top and bottom post connectors are symmetrically defined about a vertical axis of each post cap and post sleeve, respectively.

In another embodiment, the male engagement member located on each of the plurality of posts includes a member support that is coupled to both the male engagement member and to a surface of the post.

In yet another embodiment, each of the plurality of posts within the system includes a top coupling portion and a bottom coupling portion, both the top coupling portion and the bottom coupling portion having a smaller cross sectional area relative to the main body of the post. Specifically, each post also includes a stop that is located around the circumference of the post at the intersection between the top coupling portion and the post as well as the intersection between the bottom coupling portion and the post. Additionally, each post cap includes an aperture defined through its surface so as to accommodate the top coupling portion of the posts therein, while in turn each post sleeve includes an aperture defined there through so as to thread the bottom coupling portion of the posts through the post sleeve.

In yet another embodiment, the male engagement member of each of the plurality of posts includes a cylindrical body which protrudes from a plane defined by a surface of the post.

In another embodiment, the female engagement members on each of the top and bottom post connectors each include a semi-circular aperture defined through at least one surface of each post cap and post sleeve, respectively.

The current invention also provides a method for forming a shelving system resistant to applied shear forces. The method includes disposing a plurality of posts in a vertical orientation, coupling a top post connector to at least two of the plurality of posts, and then coupling a bottom post connector to at least two of the plurality of posts. The top and bottom post connectors are coupled to the posts by first disposing a female engagement member defined in each of the plurality of top and bottom post connectors over a male engagement member located on each of the posts so as to fully accommodate the male engagement member within the female engagement member. Next, a surface of the female engagement member is pressed against a surface of the male engagement member so that the male engagement member may apply a reaction force in any direction to the female engagement member in response to a shear force applied to the shelving system.

In one embodiment, pressing a surface of the female engagement member against the surface of the male engagement member so that the male engagement member may apply a reaction force in any direction to the female engagement member in response to a shear force applied to the shelving system specifically includes pressing a concave surface of the female engagement onto or against a rounded surface of the male engagement member.

In yet another embodiment, coupling the top post connector to two of the posts specifically includes inserting a top coupling portion of each of the posts into a corresponding pair of post caps located on the top post connector and then pressing the post caps onto the posts until each of the post caps makes contact with a stop disposed on each of the posts.

In a related embodiment, coupling the bottom post connector to two of the posts specifically includes inserting a bottom coupling portion of each of the posts into a corresponding pair of post sleeves located on the bottom post connector and then pressing the post sleeves onto the posts until each of the post sleeves makes contact with a stop disposed on each of the posts. In this embodiment, pressing the post sleeves onto the posts until each of the post sleeves makes contact with a stop disposed on each of the posts further involves threading the bottom coupling portion of each of the posts through each of the post sleeves.

In yet another embodiment, disposing a female engagement member defined in each of the top and bottom post connectors over a male engagement member disposed on each of the posts so as to fully accommodate the male engagement member within the female engagement member specifically includes forming a plane defined by the male engagement member inserted into the female engagement member, wherein the plane is parallel to any shear forces applied to the shelving system.

In a further embodiment, the method includes connecting a plurality of traverses to a corresponding plurality of traverse coupling positions disposed along the height of at least two of the posts. Specifically, each traverse is connected to a post by coupling a traverse end piece disposed at either lateral end of the traverse to either a first or second male component which define each of the traverse coupling positions. The traverse end piece is coupled to either the first or second male component by inserting the selected male component into a female aperture that is defined within the traverse end piece itself.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1A is a planar view of a longitudinal side of the shelving system of the current invention.

FIG. 1B is a bottom perspective view of the shelving system seen in FIG. 1A.

FIG. 1C is a top perspective view of the shelving system seen in FIG. 1A.

FIG. 1D is planar view of a lateral side of the shelving system seen in FIG. 1A.

FIG. 1E is top down view of the shelving system seen in FIG. 1A.

FIG. 2A is a bottom perspective view of a top post connector included within the shelving system of the current invention.

FIG. 2B is a bottom view of the top post connector seen in FIG. 2A.

FIG. 2C is a magnified frontal view of a post cap coupled to the top post connector seen in FIG. 2A.

FIG. 3 is a side view of a post included within the shelving system of the current invention.

FIG. 4A is a magnified side view of the top portion of the post seen in FIG. 3.

FIG. 4B is a frontal view of the top portion of the post seen in FIG. 4A.

FIG. 5A is a magnified side view of the bottom portion of the post seen in FIG. 3.

FIG. 5B is a frontal view of the top portion of the post seen in FIG. 5A.

FIG. 6A is a top perspective view of the bottom post connector including within the shelving system of the current invention.

FIG. 6B is a magnified frontal view of a post sleeve coupled to the bottom post connector seen in FIG. 6A.

FIG. 7 is a magnified frontal view of the post cap seen in FIG. 2C after being coupled to the top portion of a post.

FIG. 8 is a magnified frontal view of the post sleeve seen in FIG. 6B after being coupled to the bottom portion of a post.

FIG. 9 is a magnified view of the coupling between a male frictional engagement member of a post and a female frictional engagement member of either a top or bottom post connector.

FIG. 10A is a cross sectional view of the top post connector coupled to a pair of posts.

FIG. 10B is a cross sectional view of the bottom post connector coupled to a pair of posts.

FIG. 11 is a cross sectional longitudinal view of the shelving system seen in FIG. 1A.

FIG. 12A is a bottom perspective view of a traverse end piece coupled to a first male component defining the traverse coupling positions disposed along the height of a post.

FIG. 12B is a bottom perspective view of a traverse end piece coupled to a second male component defining the traverse coupling positions disposed along the height of a post.

FIG. 12C is a frontal view of the traverse end piece coupled to the first male component seen in FIG. 12A.

FIG. 13 is a perspective exploded view of the shelving system seen in FIG. 1A.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

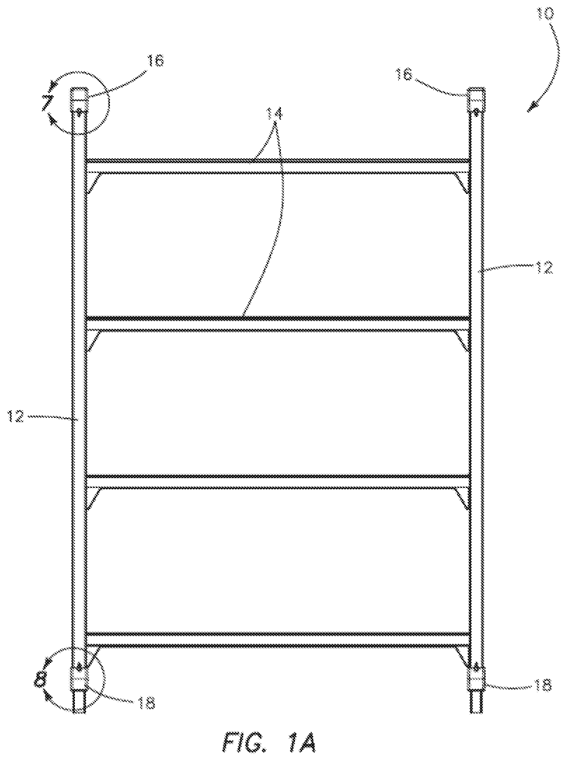

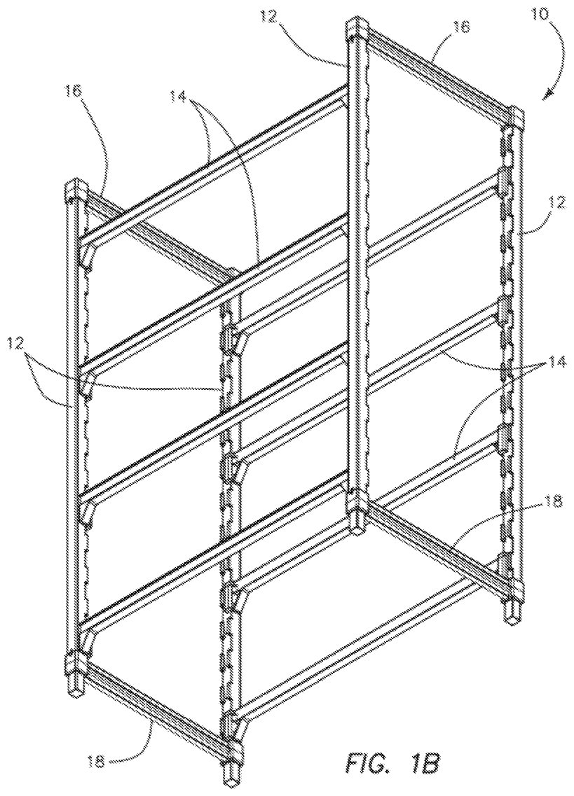

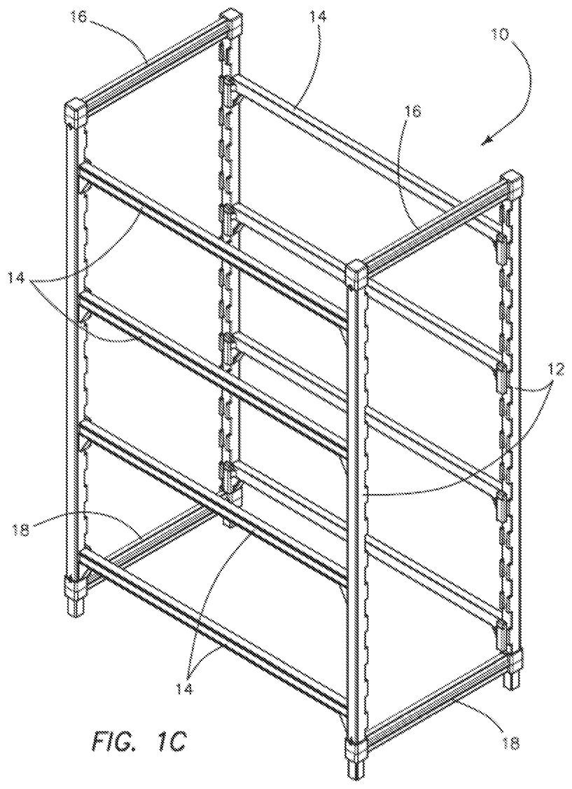

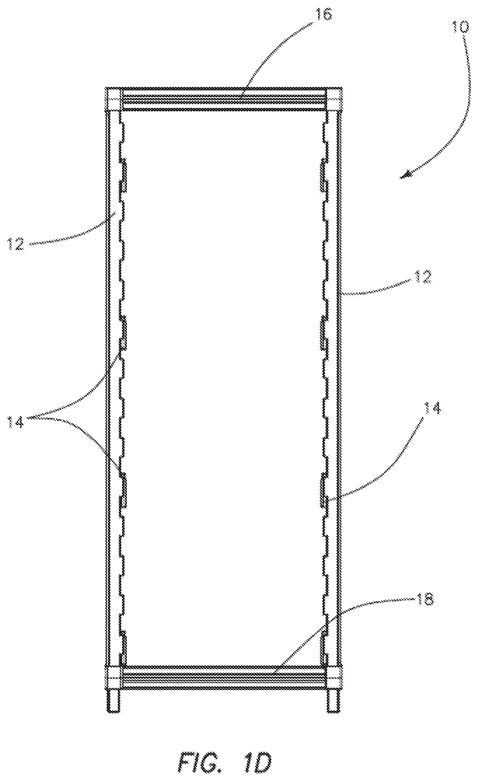

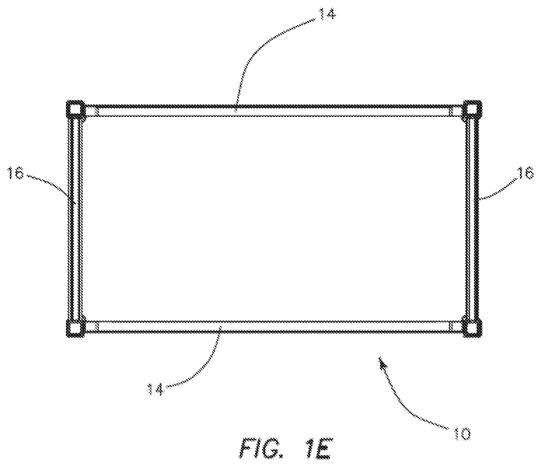

A first embodiment of the current invention is seen in FIGS. 1A-1E where the shelving system is generally denoted by reference numeral 10. The shelving system primarily comprises a plurality of vertical posts 12 arranged in a substantially rectangular pattern. One vertical post 12 is preferably disposed at each respective corner of the rectangle. While there are four vertical posts 12 shown in FIGS. 1A-1E, it is important to note that any number of vertical posts may be used in any number of configuration such as squares, circles, semi-circles and the like without departing from the original spirit and scope of the invention.

Disposed laterally between the plurality of vertical posts 12 are a plurality of horizontal traverses 14. In the embodiment best seen in FIGS. 1B and 1C, the horizontal traverses 14 are paired up in parallel groups of two and are coupled to vertical posts 12 at either end of each traverse 14. Each parallel pair of traverses 14 thereby forms a support structure or a frame for a shelf. Specifically, each parallel pair of traverse 14 may accommodate a plurality of removable shelf plates, storage containers or modules, or any other adjustable, removable, or configurable components related to a shelving system now known or later devised. It should also be noted that fewer or additional traverses 14 other than what is explicitly shown in FIGS. 1A-1E may be used without departing from the original spirit and scope of the invention. For example, FIG. 1C shows four pairs of parallel traverses 14 thereby providing at least four frames or supports for four different shelving areas, however additional pairs of traverses 14 may be present thereby providing more options for the user to dispose shelving plates or other shelving system related components at different levels or heights within the shelving system 10.

The vertical posts 12 and horizontal traverses 14 of the shelving system 10 are made by a pultrusion process comprising the following steps of providing a supply of fiberglass rovings, guiding fibers from the fiberglass rovings through a resin impregnator, saturating the fibers with resin from the resin impregnator, pulling the saturated fibers through a forming die, forming the fibers to a predetermined shape to form a pultruded component, and cutting the formed pultruded traverse or post to a predetermined length. Specifically, both the primary horizontal traverses 14 and the primary vertical posts 12 are comprised of plastic or plastic composites and are fabricated by the known process of pultrusion.

The process of pultrusion in general includes a plurality of strands of fiberglass or other suitable material being extruded from a plurality of rovings disposed on a rack by a plurality of pulleys or other suitable means. The strands of fiberglass are brought together with other materials such as mats and are placed in a resin bath or are otherwise impregnated with resin and other substances that bind the roving strands together in a resin impregnator. The resin may either be liquid or powder based depending on the type of fiberglass material being supplied by the rovings, and may include a mixture of one or more thermosetting or thermoplastic resins. Various types of filament winding may be added if desired to the resin infused strands by an in-line winder. Adding a filament winding increases the bi-axial strength of the pultruded component. The resin infused strands are then mechanically pulled by a set of roving pullers through a set of performers which help the fiberglass rovings obtain an initial rough shape before being pulled through a curring die which forms the fiberglass to a permanent predetermined shape. After being pulled, heated, or cured, a saw then cuts the pultruded component down to a desired length or plurality of lengths.

In the preferred embodiment of the current invention, the horizontal traverses 14 and vertical posts 12 are comprised of a mixture of 70% to 80% glass and 20% to 30% resin. The fiberglass being fed from the rovings is a continuous filament of 2025 Fiver glass. As the fiberglass enters the resin impregnator 176, a resin comprising 50% BAYDUR PUL2500 (Polymeric Diphenyimethane Diisocyanate (pMDI)), 47.32% BAYDURE PUL2500 (Polyol System), 2.07% mold release (AXEL INT-1948MCH), and 0.25% color load (REBUS Code 70165) is impregnated onto the fiberglass. After each of the components have been properly cured, molded, and cut, the resulting product is an extremely strong and durable structural element for the shelving system 10 that is still lightweight enough to be easily carried or otherwise manipulated. It is to be expressly understood however that other similar types of fiberglass or resins may be used in differing proportions from what is listed here without departing from the original spirit and scope of the invention.

Coupled to a top portion of at least two adjacently disposed vertical posts 12 is a top post connector 16. Similarly, coupled to a bottom portion of at least two adjacently disposed vertical posts 12 is a bottom post connector 18. Both the top post connectors 16 and the bottom post connectors 18 are orientated perpendicularly relative to the plurality of traverses 14 as best seen in the top down view of the shelving system 10 of FIG. 1E. Additionally, both the top post connectors 16 and bottom post connectors 18 are preferably comprised of injection molded plastic or plastic composites.

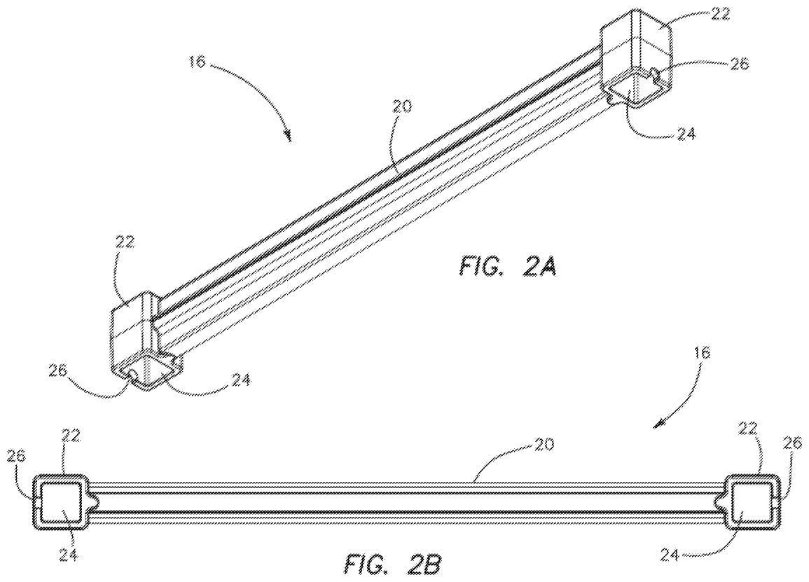

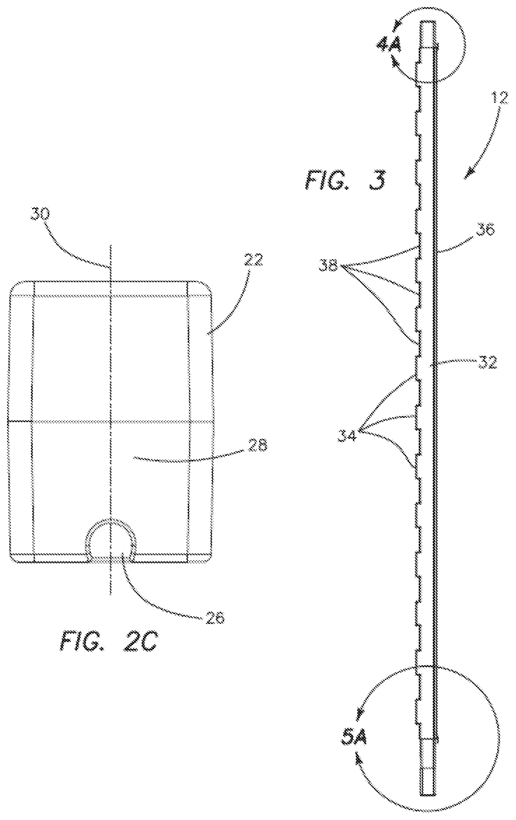

Greater detail of the top post connectors 16 may be seen in FIGS. 2A-2C. Each top post connector 16 comprises a substantially longitudinal crosspiece 20 with a substantially cuboidal post cap 22 disposed on either lateral end of the crosspiece 20. Each post cap 22 comprises a post aperture 24 which is defined in its bottom surface. The post cap 22 forms a shell or is otherwise hollow so that a top portion or tip of a vertical post 12 may be accommodated or nested therein by being disposed or inserted into the internal volume of the post cap 22 through the post aperture 24 as is detailed further below.

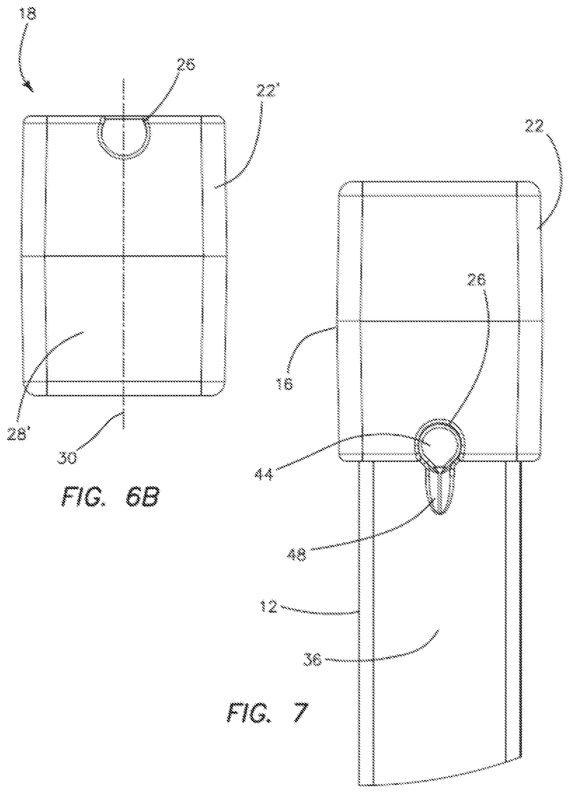

In turn, greater detail of the bottom post connectors 18 may be seen in FIGS. 6A and 6B. Like the top post connector 16 discussed above, each bottom post connector 18 comprises a substantially longitudinal crosspiece 20 with a substantially cuboidal post sleeve 22′ disposed on either lateral end of the crosspiece 20. Each post sleeve 22′ comprises a post aperture 24 which is defined in both its top and bottom surface. The post sleeve 22′ forms a shell or is otherwise hollow so that the bottom portion of the vertical post 12 may be accommodated or disposed therein by being inserted into the internal volume of the post sleeve 22′ through the post aperture 24 as is detailed further below.

Each post cap 22 and post sleeve 22′ comprises a cutout or female frictional engagement member 26 defined in at least one surface of the post cap 22 or post sleeve 22′. Specifically, as best seen in the bottom view of the top post connector 16 of FIG. 2B and the perspective view of the bottom post connector 18 of FIG. 6A, the female frictional engagement member 26 is defined completely through at least one edge or surface of the post cap 22 or the post sleeve 22′ so as to form an asymmetrical bottom or top footprint, respectively. FIGS. 2C and 6B further specify that the female frictional engagement member 26 is defined at or approximate to the bottom of a front surface 28 of the post cap 22 and at the top of a front surface 28′ of the post sleeve 22′. Additionally, the female frictional engagement member 26 is substantially centrally or symmetrically defined along a vertical axis 30 of the front surface 28 of the post cap 22 and of the front surface 28′ of the post sleeve 22′, respectively.

The female frictional engagement member 26 is seen in FIGS. 2C and 6B as being substantially circular or semi-circular in shape, however it is to be expressly understood that other shapes, sizes, or configurations may be used without departing from the original spirit and scope of the invention. For example, the female frictional engagement member 26 may comprise any shape which is capable or configured to frictionally engage another component inserted into it over a majority of its inner surface as defined within the respective front surfaces 28, 28′ of the post cap 22 and post sleeve 22′. Such shapes or configurations include but are not limited to triangular, rectangular or parallelepiped, pentagonal, hexagonal, or octagonal. Additionally, while the female frictional engagement member 26 is seen in FIGS. 2B, 2C, and 6B as a hole or aperture defined through the front surface 28, 28′, it is to be expressly understood that the female frictional engagement member 26 may comprise an additional surface or contact point beyond what is provided by the edge or thickness of the front surface 28, 28′ itself. For example, the female frictional engagement member 26 may comprise a hood, ridge, or other projection or extension which extends out in a perpendicular direction relative to the vertical orientated front surface 28 so that a contact point or frictional surface is formed other than at the position or vertical plane shared by the front surface 28, 28′ itself.

Greater detail of the vertical posts 12 may be had by turning to FIGS. 3-5B. As seen in FIG. 3, each vertical post 12 comprises an elongated body 32 with a smooth or flat outer surface 36 and an inner surface 38 which comprises a plurality of traverse coupling positions 34 disposed along the height of the vertical post.

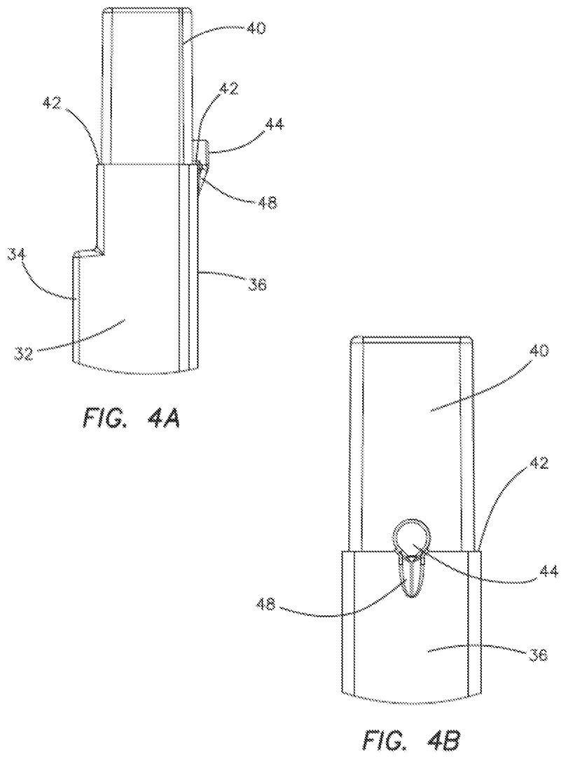

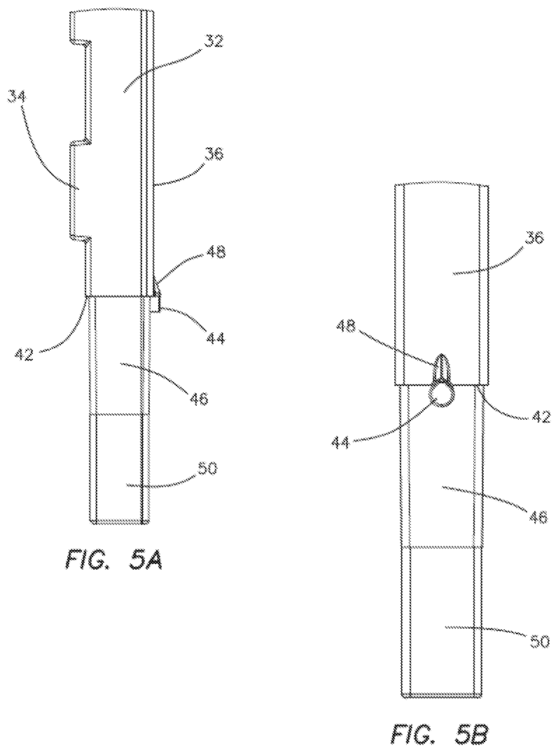

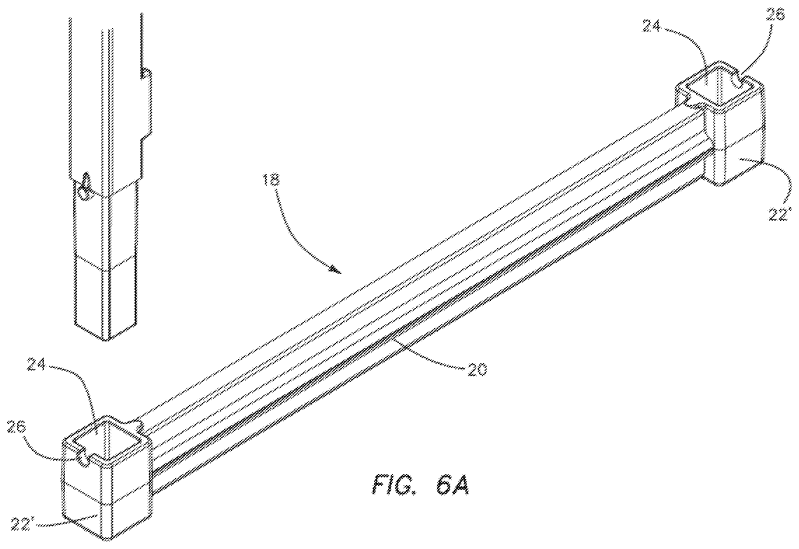

The top and bottom portions of each vertical post 12 may be seen in FIGS. 4A-4B and 5A-5B, respectively. In FIGS. 4A and 4B, it can be seen that the top portion of each vertical post 12 comprises a top coupling portion 40 which comprises a slightly smaller width or cross sectional area than the body 32 of the vertical post 12 from which the top coupling portion 40 extends. Because the top coupling portion 40 has a smaller cross sectional area relative to the body 32, a stop 42 is formed around the entire circumference or perimeter of the vertical post 12, specifically at the intersection or joint between the body 32 and the top coupling portion 40. Also disposed at the joint or stop 42 between the body 32 and the top coupling portion 40 is a male frictional engagement member 44 and a member support 48. The male frictional engagement member 44 extends perpendicularly outward from a longitudinal axis of the top coupling portion 40 beyond the vertical plane defined by the outer surface 36 of the body 32. The member support 48 is coupled or integrally formed with a bottom portion of the male frictional engagement member 44 and extends vertically downward, over the outer surface 36 of the body 32 portion of the vertical post 12. As seen in FIG. 4A, the member support 48 is substantially tapered in the vertical direction, specifically with a maximum height at or near the male frictional engagement member 44 and a decreasing height as the member support 48 is disposed downward vertically relative to the body 32 until becoming flush or even with the outer surface 36 of the body 32.

Turning to FIGS. 5A and 5B, the bottom portion of each vertical post 12 is seen which comprises a bottom coupling portion 46 which comprises a slightly smaller width or cross sectional area than the body 32 of the vertical post 12 from which the bottom coupling portion 46 extends. Like the top coupling portion 40 discussed above, because the bottom coupling portion 46 has a smaller cross sectional area relative to the body 32, a stop 42 is formed around the entire circumference or perimeter of the vertical post 12, specifically at the intersection or joint between the body 32 and the bottom coupling portion 46. Also disposed at the joint or stop 42 between the body 32 and the bottom coupling portion 46 is a male frictional engagement member 44 and a member support 48. The male frictional engagement member 44 extends perpendicularly outward from a longitudinal axis of the bottom coupling portion 46 beyond the vertical plane defined by the outer surface 36 of the body 32. In this instance, the member support 48 is coupled or integrally formed with a top portion of the male frictional engagement member 44 and extends vertically upward, over the outer surface 36 of the body 32 portion of the vertical post 12. As seen in FIG. 5A, the member support 48 is substantially tapered in the vertical direction, specifically with a maximum height at or near the male frictional engagement member 44 and a decreasing height as the member support 48 is disposed upward vertically relative to the body 32 until becoming flush or even with the outer surface 36 of the body 32. Disposed beneath the bottom coupling portion 46 is a foot 50 which makes contact with the ground or surface on which the shelving system 10 rests. The foot 50 may be comprised of the same pultruded material as the body 32 of the vertical posts 12, or alternatively, may be comprised of a different form of plastic such as injection molded plastic or a different material entirely such as metal or rubber.

Regardless where it is disposed relative to the body 32 of the vertical post 12, the male frictional engagement member 44 seen in FIGS. 4B and 5B is seen as being substantially circular, semi-circular, or cylindrical in shape, however it is to be expressly understood that other shapes, sizes, or configurations may be used without departing from the original spirit and scope of the invention. For example, the male frictional engagement member 44 may comprise any shape which is capable or configured to frictionally engage another component into which the male frictional engagement member 44 is inserted, specifically over a majority of its outer surface as defined by the shape of the male frictional engagement member 44 itself. Such shapes or configurations include but are not limited to a tetrahedron, cuboid, sphere, cone, helix, or some combination thereof. Additionally, while the male frictional engagement member 44 is seen in FIGS. 4B and 5B as a cylinder with substantially smooth surfaces, it is to be expressly understood that the male frictional engagement member 44 may comprise an additional surface or structural feature beyond what is provided by the general shape of the male frictional engagement member 44 itself. For example, the male frictional engagement member 44 may comprise a helical screw thread, a toggle bolt, a notch or defined aperture, an anchor, or other receiving joint which is capable of creating or forming a contact point or other frictional surface. Additionally, construction material substances such as adhesive or mortar may be applied over the surface of the male frictional engagement member 44 to enhance its ability to couple or affix itself to another component.

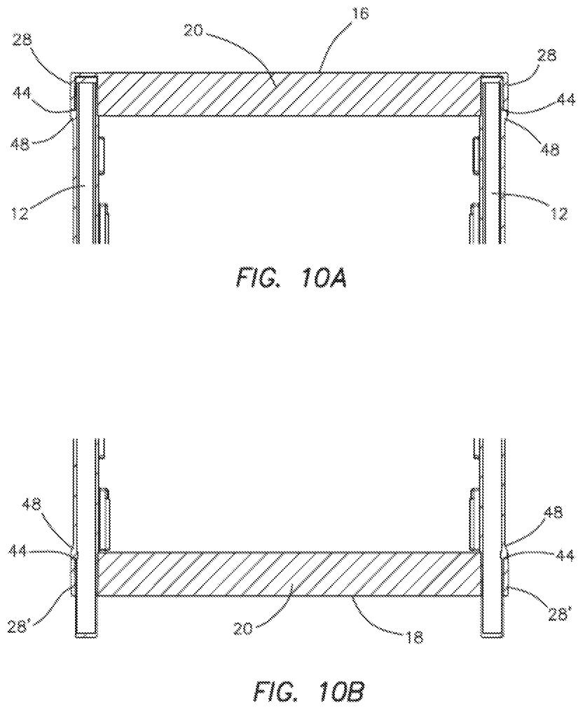

Turning to FIGS. 4B and 7, the frictional coupling or engagement between the top post connector 16 and a vertical post 12 may be seen. First, the top post connector 16 is disposed over the top coupling portion 40 of the vertical post 12, specifically with the post aperture 24 defined in the bottom surface of the post cap 22 aligned or disposed directly over the top coupling portion 40. The post cap 22 is brought vertically downward over the top coupling portion 40 so that it enters or is inserted through the post aperture 24 and into the hollow interior volume of the post cap 22. As the top post connector 16 is pushed downward, the male frictional engagement member 44 disposed on the body 36 of the vertical post 12 is inserted or moves into the female frictional engagement member 26 defined within the post cap 22. The male frictional engagement member 44 is nested within the female frictional engagement member 26 so that an entirety of an internal surface of the female frictional engagement member 26 is in physical contact with a corresponding outside surface of the male frictional engagement member 44. At the same time the male frictional engagement member 44 is inserted into the female frictional engagement member 26, a bottom portion or edge of the post cap 22 makes contact with the stop 42 disposed between the body 36 and the top coupling portion 40. After making contact with the male frictional engagement member 44 and the stop 42, all further downward movement of the post cap 22 and thus the top post connector 16 as a whole relative to the vertical post 12 is prevented. Each post cap 22 of the top post connector 16 may be coupled to a vertical post 12 individually, or the post caps 22 may be coupled to two different vertical posts 12 simultaneously, thereby helping form one lateral side of the shelving system 10 as seen in FIG. 10A.

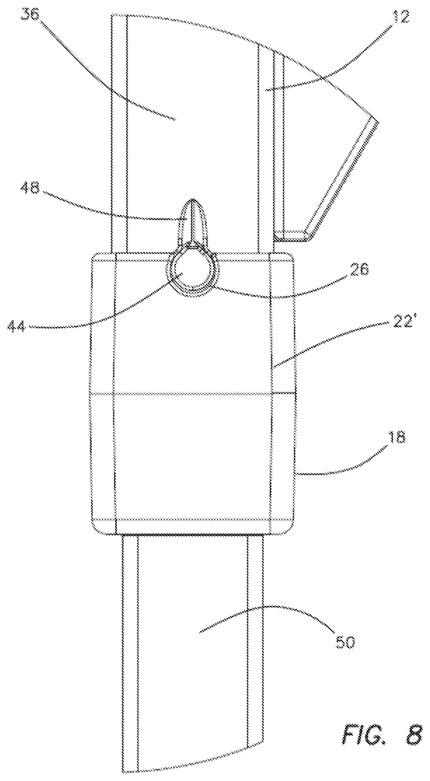

The frictional coupling or engagement between the bottom post connector 18 and a vertical post 12 may be seen in FIGS. 5B and 8. First, the bottom post connector 18 is disposed beneath or under the foot 50 and bottom coupling portion 46 of the vertical post 12, specifically with the post aperture 24 defined in the top surface of the post sleeve 22′ aligned or disposed directly under the bottom coupling portion 46. The post sleeve 22′ is brought vertically upward over the foot 50 and bottom coupling portion 46 so that it enters or is inserted through the post aperture 24 and into the hollow interior volume of the post sleeve 22′. Because a post aperture 24 is defined through both the top and bottom surfaces of the post sleeve 22′, as the bottom post connector 18 is moved over the height of the vertical post 12 the foot 50 is allowed to extend through or traverse the entire height of the post sleeve 22′ and exit through the opposing side as seen in FIG. 10B, thereby allowing the bottom post connector 18 to then move over the bottom coupling portion 46. As the bottom post connector 18 is further pushed or moved upward over the bottom coupling portion 46, the male frictional engagement member 44 disposed on the body 36 of the vertical post 12 is inserted or moves into the female frictional engagement member 26 defined within the post sleeve 22′. The male frictional engagement member 44 is nested within the female frictional engagement member 26 so that an entirety of an internal surface of the female frictional engagement member 26 is in physical contact with a corresponding outside surface of the male frictional engagement member 44. At the same time the male frictional engagement member 44 is inserted into the female frictional engagement member 26, a top portion or edge of the post sleeve 22′ makes contact with the stop 42 disposed between the body 36 and the bottom coupling portion 46. After making contact with the male frictional engagement member 44 and the stop 42, all further upward movement of the post sleeve 22′ and thus the bottom post connector 18 as a whole relative to the vertical post 12 is prevented. Each post sleeve 22′ of the bottom post connector 18 may be coupled to a vertical post 12 individually, or the post sleeves 22′ may be coupled to two different vertical posts 12 simultaneously, thereby helping form one lateral side of the shelving system 10 as seen in FIG. 10B.

It is important to note that the frictional engagement between the vertical posts 12 and both the top post connector 16 and the bottom post connector 18 is a key aspect in maintaining the overall structural integrity of the shelving system 10, particularly with regard to withstanding applied horizontal or shear forces. Specifically, as best seen in FIGS. 7 and 8 and as discussed above, both the male frictional engagement member 44 and the correspondingly shaped female frictional engagement member 26 each comprise substantially circular shapes or otherwise comprise at least one surface which is rounded, curved, or containing at least one segment defined by an arc. By having correspondingly shaped or mirror-image curved surfaces between the male and female frictional engagement members 44, 26, the amount of surface contact between the male and female frictional engagement members 44, 26 is increased relative to what would be possible employing a straight or angled contact surface. A large amount of surface contact in turn leads to a large amount of friction between the male and female frictional engagement members 44, 26 which helps keep the top and bottom post connectors 16, 18 firmly coupled to their respective positions along each vertical post 12.

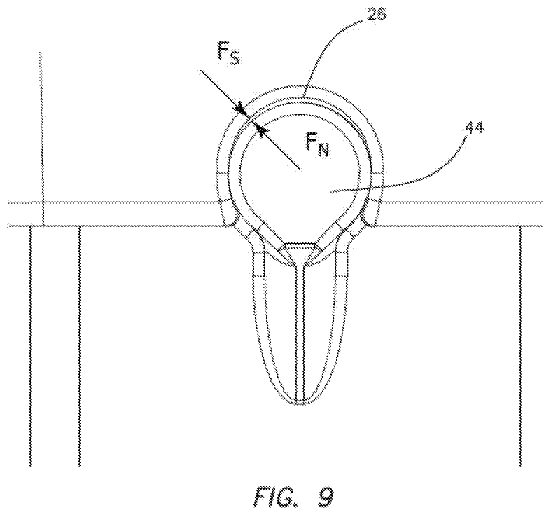

Additionally, because the male and female frictional engagement members 44, 26 form a substantially concentric configuration when coupled together, any shear forces applied or exerted to any portion of the shelving system 10 is met with a radial reactive force which opposes the applied shear force in both direction and magnitude. For example, if a shear force Fs as seen in FIG. 9 is applied to the shelving system 10 in the direction shown, a reaction force FR of equal magnitude but of opposing orientation will emanate from the surface contact between the male and female frictional engagement members 44, 26. As well understood, the reaction force FR helps counteract or resist any acceleration resulting from the applied shear force Fs, thereby helping the shelving system 10 as a whole maintain a relatively stable support structure for any items stored within the shelving system 10. The substantially concentric configuration formed by the male and female frictional engagement members 44, 26 ensures that a corresponding radial reaction force FR is generated by the shelving system 10 regardless of the direction or orientation of the applied or incoming shear force Fs.

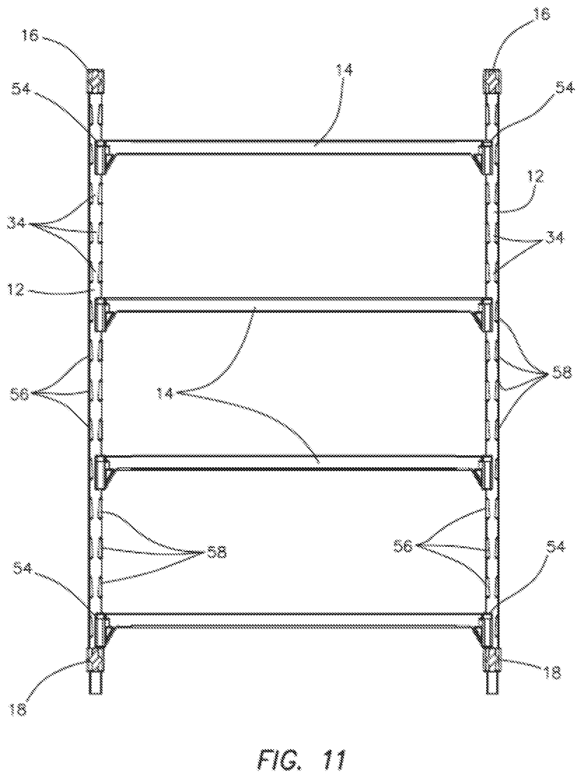

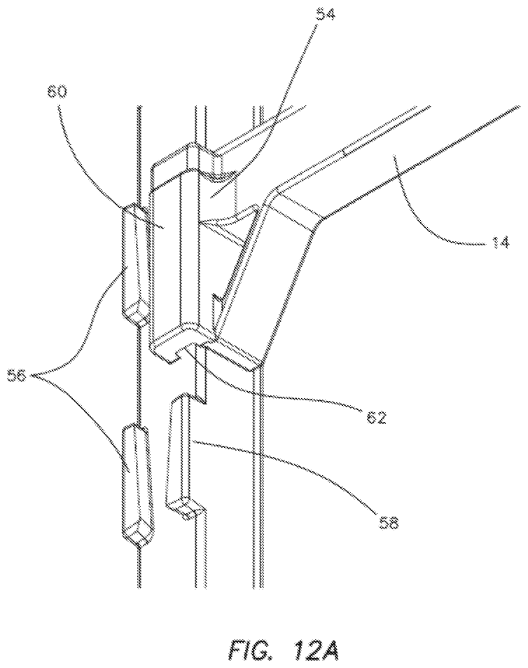

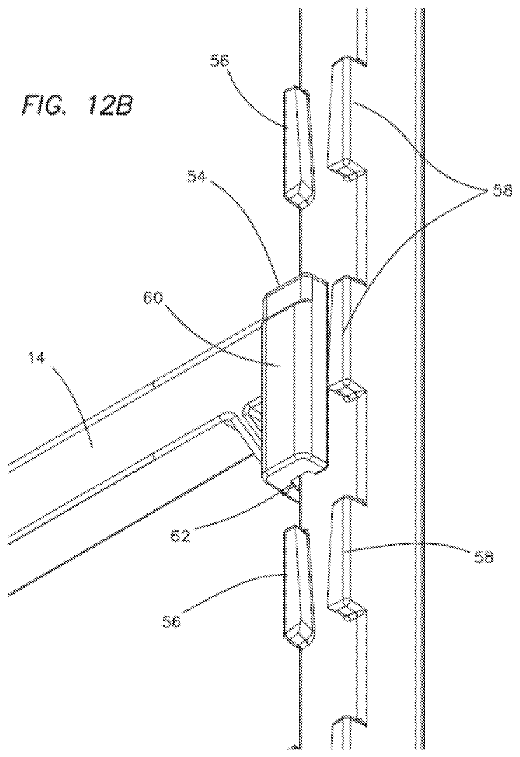

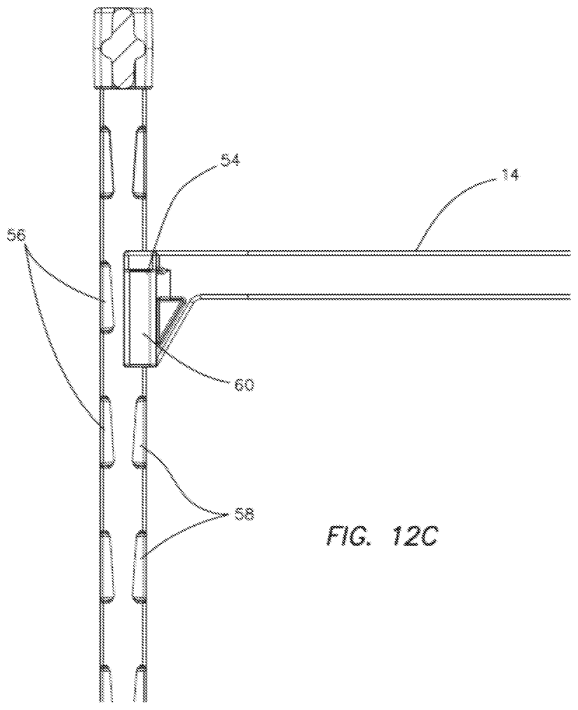

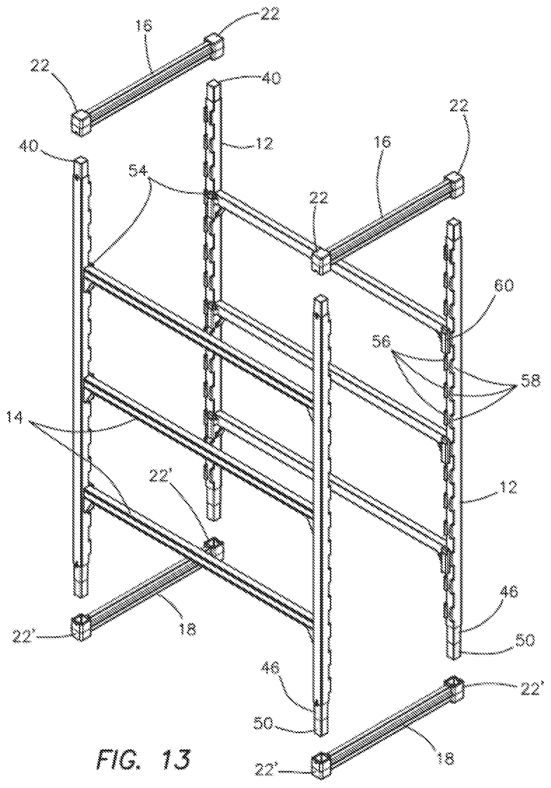

Detail of how the plurality of traverses 14 are coupled to one or more vertical posts 12 may be seen by turning to FIGS. 11-12C. Each traverse 14 comprises a substantially rectangular or parallelepiped shaped body 52 which is comprised of pultruded plastic or plastic composites. Disposed or coupled to either lateral end of the body 52 is a traverse end piece 54. Each traverse end piece 54 may be coupled to a traverse 14 or alternatively, may be integrally formed with the traverse 14 to form one solid component. In turn, each vertical post 12 comprises a plurality of traverse coupling positions 34 which each comprise a first male component 56 and a second male component 58, the second male component 58 being adjacently disposed in close proximity and at the same vertical position as the first male component 56 along the vertical post 12. Each of the traverse coupling positions 34 represents a height along the vertical post 12 at which a traverse 14 may be coupled or disposed, thereby providing a platform or means for accommodating items or goods at that specified height within the shelving system 10 as a whole.

As seen in greater detail in FIGS. 12A-12C, both the first male component 56 and the second male component 58 comprise a substantially tapered or dove-tailed width while having a substantially rectangular or block-shaped depth as best seen in FIG. 5A. The first and second male components 56, 58 specifically comprise a first width at a top or proximal portion which widens or enlarges along the vertical height of the first and second male components 56, 58 so that a maximum second width is obtained at a bottom or distal portion of each of the first and second male components 56, 58, the second width being larger or wider than the first width. In contrast, each first and second male components 56, 58 comprises a depth which is consistent along its entire height, thereby providing a substantially straight or rectangular shaped profile best seen in FIG. 5A. The first male component 56 and the second male component 58 further comprise asymmetric configurations or shapes so that an outside edge of each of the first and second male components 56, 58 remains straight throughout their respective heights, while their corresponding inside edges, namely the edges which are closest to the center of the vertical post 12, flare out or gradually widen when moving from the top or proximal portion of the first and second male components 56, 58 to their respective bottom or distal portions. Furthermore, as best seen in FIG. 12C, the first and second male components 56, 58 are inversely orientated relative to one another so as to form a substantial mirror-image configuration. In other words, the tapered inside edges of the first and second male components 56, 58 forming each traverse coupling position 34 are orientated so as to be facing one another and thereby form a substantial “V” shape within the negative space disposed between the first and second male components 56, 58.

In order to couple a traverse 14 to a vertical post 12, a user first brings a traverse end piece 54 to a selected traverse coupling position 34 that is disposed at the desired height along the vertical post 12 at which the user wishes to provide a shelf within the overall shelving system 10. The user then slides a collar 60 portion of the traverse end piece 54 down onto either the first or second male components 56, 58 forming the traverse coupling position 34, depending upon which side of the vertical post 12 the user wishes to couple the traverse 14 to. The collar 60 comprises a female aperture 62 defined in its inner facing surface so that as the collar 60 is being slid over the first or second male component 56, 58, the male component 56, 58 is inserted into the female aperture 62, thereby joining the traverse 14 to the vertical post 12.

In a preferred embodiment, the female aperture 62 comprises a substantially tapered or dove-tailed shape which is similar to the tapered shape of the first and second male components 56, 58. Specifically, the female aperture 62 specifically comprises a first width at a top or proximal portion which widens or enlarges along the vertical height of the female aperture 62 so that a maximum second width is obtained at a bottom or distal portion of the female aperture 62, the second width being larger or wider than the first width. In the embodiment of the traverse end piece 54 seen in FIGS. 12A and 12C where the collar 60 is coupled to one of the plurality of second male components 58, the female aperture 62 is defined so as to specifically accommodate or envelope the second male component 58. In a related embodiment of the traverse end piece 54 seen in FIG. 12B where the collar 60 is coupled to one of the plurality of first male components 56, the female aperture 62 is in turn defined so as to specifically accommodate or envelope the first male component 56. It is therefore contemplated that a single traverse 14 which comprises a traverse end piece 54 disposed at either end may be so configured so as to specifically comprise collars 60 which have female apertures 62 defined therein that are capable of coupling to a first male component 56 of a first vertical post 12 and to a second male component 58 of a separate, adjacent vertical post 12 as seen in FIG. 11.

It is important to point out that due the substantially dove-tailed shapes of both the female aperture 62 of the collar 60 and the first and second male components 56, 58 of the traverse end piece 54, the further the female aperture 62 is slid distally downward over the first and second male components 56, 58, the more force that is created and directed toward the center of the vertical post 12. In other words, because the female apertures 62 and the first and second male components 56, 58 comprise a dove-tailed width along their length, as the female aperture 62 and the male component 56, 58 are brought together, a static force is created which pushes the collar 60 into the vertical post 12. As more weight is added to the traverse 14, either directly or indirectly through a shelf or shelf-plate disposed on the traverse 14, the larger the static force becomes which in turn further pushes the collar 60 into the vertical post 12. The post 12 in turn responds with a reactionary force that pushes the collar 60 in the opposite direction to that of the inward force created by the load placed on the traverse 14, thus maintaining static equilibrium between the traverse 14 and vertical post 12. The combination of the force distribution scheme provided by the dove-tailed shaped components with the strength provided by the traverses 14 and posts 12 fabricated by pultrusion allows for large load amounts to be placed on the traverses 14 and thus by extension, on the entire shelving system 10 as a whole without the fear of structural failure.

Once the collar 60 of the traverse end piece 54 is fully slid down about the male components 56, 58 until a top portion of the selected male component 56, 58 makes contact with a top surface of the female aperture 62, a maximum force is created that squeezes the collar 50 tightly to the vertical post 12 and thus eliminates any need for any further coupling means. The same coupling process described above is then repeated for the opposing end of traverse 14 thus leaving the traverse 14 firmly in place laterally between two primary posts 12 on either side of the shelving system 10 as seen in FIGS. 1A-1C and 11.

To remove or decouple the traverse 14 from the post 12, the user pushes up on the traverse 14 and the traverse end piece 54. In doing so, the collar 60 of the traverse end piece 54 moves vertically up the male component 56, 58 on which it is disposed. The female aperture 62 slides vertically up the male component 56, 58, decreasing the amount of force applied to the vertical post 12 by the collar 60 along the way. Once the female aperture 62 is clear of the male component 56, 58, the user is then free to remove one or both of the traverse end pieces 54 from the vertical post 12. The user may simply remove the traverse 14 from the shelving system 10 completely, or alternatively insert each of the traverse end pieces 54 into a new pair of corresponding traverse coupling positions 34 and repeat the process described above.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

I claim:

1. A shelving system comprising:
a plurality of posts; and
a plurality of post connectors, each one of the plurality of post connectors coupled to at least two of the plurality of posts,
wherein each of the plurality of posts comprises a male engagement member,
wherein each of the plurality of post connectors comprises at least one female engagement member, and
wherein the male engagement member disposed on each of the plurality of posts is configured to apply a reaction force in any direction to the at least one female engagement member disposed on each of the plurality of post connectors in response to a shear force applied to the shelving system.

2. The shelving system of claim 1 wherein the male engagement member disposed on each of the plurality of posts is configured to apply a reaction force to the at least one female engagement member disposed on each of the plurality of post connectors when the male engagement member is inserted into the at least one female engagement member.

3. The shelving system of claim 1 wherein the at least one female engagement member disposed on each of the plurality of post connectors is defined in a surface of a post cap disposed on a lateral end of each of the plurality of post connectors, and wherein the post cap comprises an internal volume capable of accommodating a top portion of at least one of the plurality of posts.

4. The shelving system of claim 1 wherein the at least one female engagement member disposed on each of the plurality of post connectors is defined in a surface of a post sleeve disposed on a lateral end of each of the plurality of post connectors, and wherein the post sleeve comprises a hollow interior capable of threading a bottom portion of at least one of the plurality of posts there through.

5. The shelving system of claim 1 further comprising:
a plurality of traverses; and
a plurality of traverse coupling positions disposed along the height of each of the plurality of posts,
wherein each of the plurality of traverses are removably coupled to at least one of the plurality of traverse coupling positions of two of the plurality of posts.

6. The shelving system of claim 5 wherein each of the plurality of traverses comprises a traverse end piece disposed at each of its lateral ends, wherein each traverse end piece is capable of coupling to either a first male component or a second male component defining each of the plurality of traverse coupling positions.

7. The shelving system of claim 2 wherein the male engagement member and the female engagement member are in surface contact over a majority of their respective surfaces when the male engagement member is inserted into the at least one female engagement member.

8. The shelving system of claim 1 wherein the male engagement member and the female engagement member define a plane when the male engagement member is inserted into the female engagement member, and wherein the reaction force applied in any direction to the at least one female engagement member disposed on each of the plurality of post connectors is parallel to the plane defined by the male engagement member and female engagement member.

9. The shelving system of claim 1 wherein at least two male engagement members disposed on two of the plurality of posts are inserted into at least two female engagement members disposed on opposing lateral ends of at least one of the plurality of post connectors.

10. The shelving system of claim 1 wherein each of the plurality of post connectors comprise means for frictionally engaging at least one surface of at least one of the plurality of posts.

11. A system for forming a shelf unit comprising:
a plurality of posts, each of the plurality of posts comprising at least one male engagement member;
a plurality of top post connectors, each of the plurality of top post connectors comprising at least two female engagement members; and
a plurality of bottom post connectors, each of the plurality of bottom post connectors comprising at least two female engagement members,
wherein the at least one male engagement member of each of the plurality of posts comprises a rounded surface, and
wherein the at least two female engagement members of each of the plurality of top post connectors and the plurality of bottom post connectors each comprise a concave surface capable of accommodating the rounded surface of at least one male engagement member.

12. The system of claim 11 further comprising a post cap or a post sleeve disposed at either lateral end of each of the plurality of top post connectors and each of the plurality of bottom post connectors, respectively.

13. The system of claim 12 wherein the at least two female engagement members of both the plurality of top post connectors and the plurality of bottom post connectors are symmetrically defined about a vertical axis of each post cap and post sleeve, respectively.

14. The system of claim 11 wherein the at least one male engagement member of each of the plurality of posts comprises a member support coupled to the at least one male engagement member and to a surface of the post.

15. The system of claim 12 wherein each of the plurality of posts comprises a top coupling portion and a bottom coupling portion, both the top coupling portion and the bottom coupling portion comprising a smaller cross sectional area relative to the post.

16. The system of claim 15 further comprising a stop disposed around the circumference of the post at the intersection between the top coupling portion and the post and the intersection between the bottom coupling portion and the post.

17. The system of claim 15 wherein each post cap of each of the plurality of top post connectors comprises an aperture defined through a surface of the post cap so as to accommodate the top coupling portion of at least one of the plurality of posts within the post cap.

18. The system of claim 15 wherein each post sleeve of each of the plurality of bottom post connectors comprises an aperture defined through the post sleeve so as to thread the bottom coupling portion of at least one of the plurality of posts through the post sleeve.

19. The system of claim 11 wherein the at least one male engagement member of each of the plurality of posts comprises a cylindrical body protruding from a plane defined by a surface of the post.

20. The system of claim 11 wherein the at least two female engagement members of each of the plurality of top post connectors and the plurality of bottom post connectors each comprise a semi-circular aperture defined through at least one surface of each post cap and post sleeve, respectively.

21. A method for forming a shelving system resistant to applied shear forces comprising:
disposing a plurality of posts in a vertical orientation;
coupling a top post connector to at least two of the plurality of posts; and
coupling a bottom post connector to at least two of the plurality of posts,
wherein coupling the top post connector and the bottom post connector to at least two of the plurality of posts comprises:
disposing a female engagement member defined in each of the plurality of top post connectors and each of the plurality of bottom post connectors over a male engagement member disposed on each of the plurality of posts so as to fully accommodate the male engagement member within the female engagement member; and
pressing a surface of the female engagement member onto a surface of the male engagement member so that the male engagement member may apply a reaction force in any direction to the female engagement member in response to a shear force applied to the shelving system.

22. The method of claim 21 wherein pressing a surface of the female engagement member onto a surface of the male engagement member so that the male engagement member may apply a reaction force in any direction to the female engagement member in response to a shear force applied to the shelving system comprises pressing a concave surface of the female engagement onto a rounded surface of the male engagement member.

23. The method of claim 21 wherein coupling a top post connector to at least two of the plurality of posts comprises inserting a top coupling portion of each of the at least two of the plurality of posts into a corresponding pair of post caps disposed on the top post connector and pressing the post caps onto the at least two of the plurality of posts until each of the post caps makes contact with a stop disposed on each of the at least two of the plurality of posts.

24. The method of claim 21 wherein coupling a bottom post connector to at least two of the plurality of posts comprises inserting a bottom coupling portion of each of the at least two of the plurality of posts into a corresponding pair of post sleeves disposed on the bottom post connector and pressing the post sleeves onto the at least two of the plurality of posts until each of the post sleeves makes contact with a stop disposed on each of the at least two of the plurality of posts.

25. The method of claim 24 wherein pressing the post sleeves onto the at least two of the plurality of posts until each of the post sleeves makes contact with a stop disposed on each of the at least two of the plurality of posts comprises threading the bottom coupling portion of each of the at least two of the plurality of posts through each of the post sleeves.

26. The method of claim 21 wherein disposing a female engagement member defined in each of the plurality of top post connectors and in each of the plurality of bottom post connectors over a male engagement member disposed on each of the plurality of posts so as to fully accommodate the male engagement member within the female engagement member comprises forming a plane defined by the male engagement member inserted into the female engagement member, wherein the plane is parallel to the applied shear forces.

27. The method of claim 21 further comprising coupling a plurality of traverses to a corresponding plurality of traverse coupling positions disposed along the height of at least two of the plurality of posts.

28. The method of claim 27 wherein coupling a plurality of traverses to a corresponding plurality of traverse coupling positions comprises coupling a traverse end piece disposed at either lateral end of each of the plurality of traverses to either a first male component or a second male component defining each of the plurality of traverse coupling positions.

29. The method of claim 28 wherein coupling a traverse end piece disposed at either lateral end of each of the plurality of traverses to either a first male component or a second male component defining each of the plurality of traverse coupling positions comprises inserting either the first male component or the second male component defining each of the plurality of traverse coupling positions into a female aperture defined within the traverse end piece.
